(19) United States
(12) Patent Application Publication
(10) Pub. No.: US 2026/0132328 A1
(43) Pub. Date: May 14, 2026

(54) TREATMENT COMPOSITIONS INCLUDING ASPHALTENIC OIL

(71) Applicant: ChampionX LLC, Sugar Land, TX (US)

(72) Inventor: Jeremy Moloney, Katy, TX (US)

(21) Appl. No.: 19/024,090

(22) Filed: Jan. 16, 2025

Related U.S. Application Data
(60) Provisional application No. 63/624,036, filed on Jan. 23, 2024.

(51) Int. Cl. C09K 8/524; C09K 8/54

(52) U.S. Cl. CPC C09K 8/524; C09K 8/54; C09K 2208/32

(57) ABSTRACT

Treatment compositions including asphaltenic oil and one or more treatment materials including corrosion inhibitors, scale inhibitors, or a combination thereof are used coat surfaces that are subsequently contacted by one or more corrodents, one or more mineral carbonates, or a combination thereof. The resulting coatings have improved durability when compared to the same treatment materials applied to the same surface in the same amount, but in the absence of the asphaltenic oil.

### BACKGROUND

The extraction of oil and gas is intrinsically associated with produced fluid emanating from the subterranean reservoir. The produced fluid enters the wellbore from the reservoir with sufficient force to cause a flow thereof to reach a point at or above the surface of the earth, further as directed by the production tubing. Produced fluids include mixtures of water, hydrocarbons, and other compounds and/or solid materials dissolved, dispersed, or entrained therein. Produced fluids typically include one or more compounds that produce deleterious effects to the well completion components as well as downstream processing equipment. Conditions of produced fluid temperature, pH, presence and concentration of corrodents such as chlorides, H₂S, and CO₂ and scale-producing compounds such as calcium carbonate and/or magnesium carbonate determine the extent of adverse effects on the material performance of equipment components contacted by produced fluid during recovery and processing thereof.

Nearly all operators in the hydrocarbon extraction and processing industry employ corrosion inhibitors to reduce internal corrosion in metal containments, conduits, and other equipment components contacted by produced fluids containing corrodents. Corrosion inhibitors are contacted with metal surfaces in the completion string as well as in processing and refinement equipment, where they act to prevent, retard, delay, reverse, and/or otherwise inhibit the corrosion of metal surfaces, such as carbon-steel metal surfaces. Such use of corrosion inhibitors is recognized to be highly beneficial for extending equipment lifetime.

Additionally, nearly all operators in the hydrocarbon extraction and processing industry employ scale inhibitors to reduce accumulation of scale on equipment surfaces contacted with produced fluids, which typically contain high concentrations of divalent carbonates such as calcium carbonate, magnesium carbonate, and byproducts of these. “Scale” is a term of art used to describe the hard coating that forms on surfaces contacted with water having divalent carbonates dissolved therein. Scale inhibitors include, but are not limited to, oligomeric and polymeric compounds with borate, carboxylate, phosphate, sulfonate, or another anionic moiety.

However, the ability to provide effective scale inhibition or corrosion inhibition treatments to the interior surfaces of hydrocarbon recovery and processing equipment, particularly within the enclosed conduits of a completion string of a producing wellbore, is an ongoing challenge. In one commonly employed method, treatment agents such as corrosion inhibitors, scale inhibitors, and the like are applied batchwise to a producing wellbore, in amounts empirically based on well production volume. The application is a single “slug” of material, injected into the wellbore in a single batch. Using this method, treatment efficacy trails off quickly over time as fresh produced fluid flows into the wellbore, continuously reducing the concentration of treatment agent(s) in the fluid emanating therefrom. Additionally, in batch treatment, both the treatment material and equipment to inject the treatment material to the site of the wellbore must be transported to the production site each time, usually by truck. Further, batch treatments are aqueous, and each batch treatment requires a large volume of adjuvant water, such as about 350 liters to about 600 liters (about to 95 gallons to about 160 gallons) per batch, to dilute and flush the batch of corrosion inhibitor into the wellbore. The adjuvant water must be transported to the treatment site along with the treatment material and injection equipment.

In another commonly employed method, the interior surfaces of the completion string of a producing wellbore are coated directly with scale inhibition and/or corrosion inhibition treatments using a “pig”. “Pigging” is a general term for the practice of using devices-pigs-to perform various operations within the interior of hydrocarbon recovery and processing equipment, particularly within the enclosed conduits (pipes) of a completion string of a producing wellbore. Thus, for example, a pig can travel inside one or more conduits of a producing wellbore to clean the interior conduit surface (e.g. by scraping and/or chemical deposition) and/or deposit one or more coating materials directly to the interior surface of the conduit as it travels.

Accordingly, pigging is used broadly in the hydrocarbon extraction and processing industry to apply treatment materials as coatings to one or more interior surfaces of hydrocarbon recovery and processing equipment that contact produced water. Pigging is generally more efficient than batch treatment, at least because pigging does not employ large volumes of adjuvant water.

Coatings applied by pigging are typically a mixture of one or more treatment materials with a solvent such as toluene, xylene, HAN, methyl isobutyl ketone, and the like. However, even after applying a solvent-based treatment composition, the resulting treatment coatings are constantly degraded, and their efficacy decreased, as fresh corrodent- and carbonate-bearing fluid flows through the equipment, continuously challenging the coated surfaces and reducing the amount of treatment material available to benefit the surfaces by preventing corrosion and/or scale buildup.

Accordingly, there is an ongoing need in the oil and gas extraction industry for improved treatment compositions that result in longer periods of treatment efficacy when applied as a coating on the interior surfaces of the completion string of a producing wellbore.

### SUMMARY

Disclosed herein are treatment compositions for coating interior surfaces of industrial equipment. In embodiments, the industrial equipment is a completion string of a producing wellbore. In embodiments, the treatment compositions are coated by pigging.

The treatment compositions include, consist essentially of, or consist of a mixture of a treatment material and an asphaltenic oil. The asphaltenic oil includes 5 wt % to 40 wt % asphaltene in an oil. In embodiments, the asphaltenic oil includes, consists essentially of, or consists of an asphaltene and a hydrocarbon oil, a silicone oil, a plant oil, or a combination of two of more thereof. In embodiments, the treatment compositions include 1 wt % to 90 wt % of the treatment material. In embodiments, the treatment compositions further include a solvent. In embodiments, the treatment compositions are coating compositions, that is, the treatment compositions are used for coating a surface.

The treatment material includes one or more corrosion inhibitors, or one or more scale inhibitors, or a combination thereof. In embodiments, the treatment compositions include a corrosion inhibitor and an asphaltenic oil at a weight ratio of 1:9 to 9:1, for example 2:3 to 3:2, or even about 1:1. Suitable corrosion inhibitors include but are not limited to imidazolines, quaternary ammonium compounds, phosphate esters, aromatic amines, fatty acids and/or their conjugate bases, amine condensates, organic sulfur compounds, organic sulfonic acid amines, and combinations of two or more thereof.

In embodiments, the treatment compositions include a scale inhibitor and an asphaltenic oil at a weight ratio of about 1:20 to 1:1, for example 1:15 to 1:5, or even about 1:10 to 1:2. Suitable scale inhibitors include condensed phosphates, phosphonic acid and diacids thereof, polymerized organic acids, polymers comprising one or more phosphonate or phosphonate ester groups, peroxycarboxylic acids, nitrilotriacetic acid, ethylenediaminetetraacetic acid, diethylenetriamine phosphonate, a combination of two or more thereof.

Also disclosed herein is a treated surface comprising, consisting essentially of, or consisting of a coating disposed on a surface, the coating including, consisting essentially of, or consisting of a mixture of a treatment material and an asphaltene. In embodiments, the coating is formed by applying a treatment composition to the surface, wherein the treatment composition includes, consists essentially of, or consists of a mixture of one or more corrosion inhibitors, one or more scale inhibitors, and an asphaltenic oil. In embodiments, the coating includes 1 wt % to 50 wt % asphaltene. In embodiments, the thickness of the coating is 1 μm to 1 mm. In embodiments, the surface is a metal, glass, or plastic surface; in embodiments, the metal surface is a carbon steel surface, a steel alloy surface, a stainless steel surface, a copper alloy surface, a yellow metal surface, or a combination of two or more thereof. In embodiments, the surface is an interior surface of a completion string of a producing wellbore. In embodiments, the coatings are formed by pigging.

Also disclosed herein is a method of treating a surface. The method includes, consists essentially of, or consists of mixing a treatment material with an asphaltenic oil to form a treatment composition; and contacting a surface with the treatment composition to form a treated surface. In embodiments, the treated surface is a surface having a coating disposed thereon, the coating comprising, consisting essentially of, or consisting of a treatment material and an asphaltene. In embodiments, the surface is a metal, glass, or plastic surface; in embodiments, the metal surface is a carbon steel surface, a steel alloy surface, a stainless steel surface, a copper alloy surface, a yellow metal surface, or a combination of two or more thereof. In embodiments, the surface is an interior surface of a completion string of a producing wellbore. In embodiments, the contacting is applying the treatment composition to the surface to form a coating thereon, the coating having a thickness of 1 μm to 5 mm. In embodiments, the contacting is carried out in a batch treatment. In embodiments, the contacting is carried out by dip coating, brush coating, or spray coating. In embodiments, the contacting is carried out by pigging. In embodiments, the method further includes contacting the treated surface with a corrodent, a mineral carbonate, or a combination thereof. In embodiments, the method further includes contacting the treated surface with a crude oil or a produced water.

Also disclosed herein are uses of asphaltenic oil to form treatment compositions in accord with the foregoing, wherein the treatment compositions include one or more corrosion inhibitors, one or more scale inhibitors, or a combination thereof. Also disclosed herein are uses of the treatment compositions to treat a surface. Also disclosed herein are uses of the treatment compositions to form treated surfaces, wherein the treated surfaces have improved treatment durability when compared to the same treatment materials applied to the same surface in the same amount but in the absence of the asphaltenic oil.

### BRIEF DESCRIPTION OF THE DRAWINGS

FIG. 1 is a plot showing corrosion (milli-inches per year, mpy) as a function of time for a treated surface in accordance with the invention.

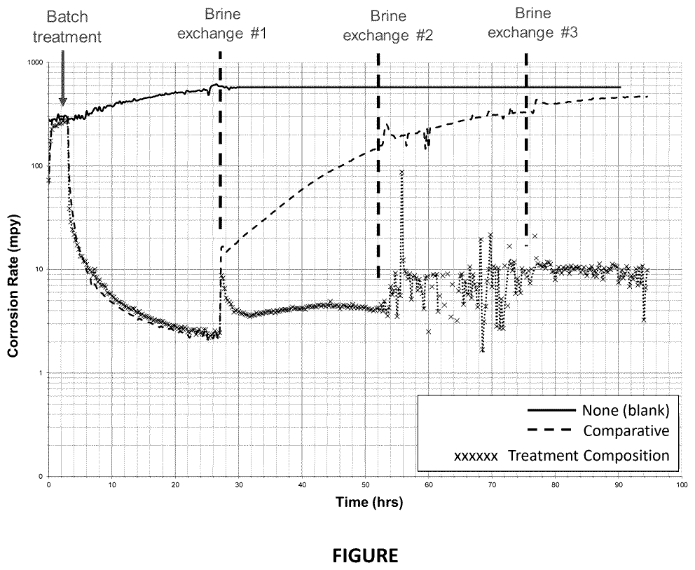

### DETAILED DESCRIPTION

Although the present disclosure provides references to preferred embodiments, persons skilled in the art will recognize that changes may be made in form and detail without departing from the spirit and scope of the invention. Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

### Definitions

As used herein, the term “oil” refers to a compound, or a mixture of two or more compounds, that is liquid at 25° C./1 atm, is hydrophobic, and has a flashpoint of at least 100° C.

As used herein, the term “hydrophobic” refers to a compound or mixture thereof having solubility in water of less than 1 wt % at 25° C./1 atm.

As used herein, the term “solvent” refers to a compound that is a fluid at 25° C./1 atm and has a flashpoint of 100° C. or less, or a mixture of two or more such compounds. The term “solvent” may refer to a single compound or a mixture of two or more compounds, as determined by context.

As used herein, the term “asphaltene” refers to the component of crude oil, bitumen, or coal that is toluene-soluble and n-heptane-insoluble; in embodiments, asphaltene is a solid, or consists essentially of a solid at 25° C./1 atm.

As used herein, the terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “optional” or “optionally” means that the subsequently described event or circumstance may but need not occur, and that the description includes instances where the event or circumstance occurs and instances in which it does not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe a range of values, for example “about 1 to 5” the recitation means “1 to 5”, “about 1 to about 5”, “1 to about 5” and “about 1 to 5” unless specifically limited by context.

As used herein, the word “substantially” modifying, for example, the type or quantity of an ingredient in a composition, a property, a measurable quantity, a method, a position, a value, or a range, employed in describing the embodiments of the disclosure, refers to a variation that does not affect the overall recited composition, property, quantity, method, position, value, or range thereof in a manner that negates an intended composition, property, quantity, method, position, value, or range. Examples of intended properties include, solely by way of non-limiting examples thereof, flexibility, partition coefficient, rate, solubility, temperature, and the like; intended values include thickness, yield, weight, concentration, and the like. The effect on methods that are modified by “substantially” include the effects caused by variations in type or amount of materials used in a process, variability in machine settings, the effects of ambient conditions on a process, and the like wherein the manner or degree of the effect does not negate one or more intended properties or results; and like proximate considerations. Where modified by the term “substantially” the claims appended hereto include equivalents to these types and amounts of materials.

### DISCUSSION

The treatment compositions described herein comprise, consist essentially of, or consist of a mixture of a treatment material with an asphaltenic oil. In embodiments, the treatment material comprises, consists essentially of, or consists of one or more corrosion inhibitors, one or more scale inhibitors, or a combination thereof.

In embodiments, the treatment compositions comprise between 1 wt % and 90 wt % of the treatment material, for example 5 wt % to 90 wt %, or 10 wt % to 90 wt %, or 20 wt % to 90 wt %, or 30 wt % to 90 wt %, or 40 wt % to 90 wt %, or 50 wt % to 90 wt %, or 60 wt % to 90 wt %, or 70 wt % to 90 wt %, or 80 wt % to 90 wt %, or 1 wt % to 80 wt %, or 1 wt % to 70 wt %, or 1 wt % to 60 wt %, or 1 wt % to 50 wt %, or 1 wt % to 40 wt %, or 1 wt % to 30 wt %, or 1 wt % to 20 wt %, or 1 wt % to 10 wt %, or 1 wt % to 5 wt %, or 5 wt % to 10 wt %, or 10 wt % to 15 wt %, or 15 wt % to 20 wt %, or 20 wt % to 25 wt %, or 25 wt % to 30 wt %, or 30 wt % to 35 wt %, or 35 wt % to 40 wt %, or 40 wt % to 45 wt %, or 45 wt % to 50 wt %, or 50 wt % to 55 wt %, or 55 wt % to 60 wt %, or 60 wt % to 65 wt %, or 65 wt % to 70 wt %, or 70 wt % to 75 wt %, or 75 wt % to 80 wt %, or 80 wt % to 85 wt %, or 85 wt % to 90 wt %, or 10 wt % to 20 wt %, or 20 wt % to 30 wt %, or 30 wt % to 40 wt %, or 40 wt % to 50 wt %, or 50 wt % to 60 wt %, or 60 wt % to 790 wt %, or 70 wt % to 80 wt %, or 1 wt % to 20 wt %, or 20 wt % to 40 wt %, or 40 wt % to 60 wt %, or 60 wt % to 80 wt %, or 30 wt % to 50 wt %, or 50 wt % to 70 wt %, or 70 wt % to 90 wt % of the treatment material. In embodiments, the balance of the treatment composition is an asphaltenic oil; in other embodiments, the balance of the treatment composition comprises, consists essentially of, or consists of asphaltenic oil and a solvent, and optionally one or more adjuvants.

In embodiments, the asphaltenic oil includes 5 wt % to 40 wt % asphaltene, for example 10 wt % to 40 wt %, or 15 wt % to 40 wt %, or 20 wt % to 40 wt %, or 25 wt % to 40 wt %, or 30 wt % to 40 wt %, or 35 wt % to 40 wt %, or 5 wt % to 35 wt %, or 5 wt % to 30 wt %, or 5 wt % to 25 wt %, or 5 wt % to 20 wt %, or 5 wt % to 15 wt %, or 5 wt % to 10 wt %, or 5 wt % to 10 wt %, or 10 wt % to 15 wt %, or 15 wt % to 20 wt %, or 20 wt % to 25 wt %, or 25 wt % to 30 wt %, or 30 wt % to 35 wt %, or 35 wt % to 40 wt %, or 10 wt % to 20 wt %, or 15 wt % to 25 wt %, or 20 wt % to 30 wt %, or 25 wt % to 35 wt %, or 30 wt % to 40 wt % asphaltene. Asphaltene is defined as the toluene-soluble, n-heptane-insoluble component of crude oil, bitumen, or coal. In embodiments, asphaltene consists essentially of or consists of a mixture of compounds that is are solid at 25° C./1 atm.

In embodiments, the asphaltenic oil includes 60 wt % to 95 wt % of an oil, for example 65 wt % to 95 wt %, or 70 wt % to 95 wt %, or 75 wt % to 95 wt %, or 80 wt % to 95 wt %, or 85 wt % to 95 wt %, or 90 wt % to 95 wt %, or 60 wt % to 90 wt %, or 60 wt % to 85 wt %, or 60 wt % to 80 wt %, or 60 wt % to 75 wt %, or 60 wt % to 70 wt %, or 60 wt % to 65 wt %, or 65 wt % to 75 wt %, or 70 wt % to 80 wt %, or 75 wt % to 85 wt %, or 80 wt % to 90 wt %, or 85 wt % to 95 wt %, or 65 wt % to 70 wt %, or 70 wt % to 75 wt %, or 75 wt % to 80 wt %, or 80 wt % to 85 wt %, or 85 wt % to 90 wt % of an oil. The oil is a liquid at 25° C./1 atm, has a flashpoint of greater than 100° C., and is hydrophobic, where “hydrophobic” refers to a compound having solubility in water of less than 1 wt % at 25° C./1 atm. In embodiments, the oil is a substantially a single compound; in other embodiments the oil is a mixture of two or more compounds. In embodiments, the oil is a hydrocarbon oil, a silicone oil, a plant oil such as soybean, sunflower, or safflower oil or a drying oil such as linseed or tung oil, or a combination of two of more thereof. Hydrocarbon oils are petroleum based oils including crude oils and refined products thereof such as fuel oils and lubricating oils. In embodiments, the oil comprises, consists essentially of, or consists of a crude oil. In embodiments, an asphaltene is added to an oil or to an oil/CI combination in a selected amount for forming the treatment compositions. In other embodiments, a crude oil is an asphaltenic oil, wherein the crude oil includes 5 wt % to 40 wt % asphaltene as described above; and no additional asphaltene is added to the crude oil or to a treatment composition formed from the crude oil.

In embodiments, the treatment compositions comprise, consist essentially of, or consist of a mixture of an asphaltenic oil, a treatment material, and a solvent. In such embodiments, the treatment compositions include between 1 wt % and 80 wt % of the solvent, for example 5 wt % to 80 wt %, or 10 wt % to 80 wt %, or 20 wt % to 80 wt %, or 30 wt % to 80 wt %, or 40 wt % to 80 wt %, or 50 wt % to 80 wt %, or 60 wt % to 80 wt %, or 70 wt % to 80 wt %, or 1 wt % to 70 wt %, or 1 wt % to 60 wt %, or 1 wt % to 50 wt %, or 1 wt % to 40 wt %, or 1 wt % to 30 wt %, or 1 wt % to 20 wt %, or 1 wt % to 10 wt %, or 1 wt % to 5 wt %, or 5 wt % to 10 wt %, or 10 wt % to 15 wt %, or 15 wt % to 20 wt %, or 20 wt % to 25 wt %, or 25 wt % to 30 wt %, or 30 wt % to 35 wt %, or 35 wt % to 40 wt %, or 40 wt % to 45 wt %, or 45 wt % to 50 wt %, or 50 wt % to 55 wt %, or 55 wt % to 60 wt %, or 60 wt % to 65 wt %, or 65 wt % to 70 wt %, or 70 wt % to 75 wt %, or 75 wt % to 80 wt %, or 10 wt % to 20 wt %, or 20 wt % to 30 wt %, or 30 wt % to 40 wt %, or 40 wt % to 50 wt %, or 50 wt % to 60 wt %, or 60 wt % to 70 wt %, or 70 wt % to 80 wt %, or 1 wt % to 20 wt %, or 20 wt % to 40 wt %, or 40 wt % to 60 wt %, or 60 wt % to 80 wt % of the solvent. In embodiments, the solvent is a substantially a single compound; in other embodiments the solvent is a mixture of two or more compounds. In embodiments, the solvent comprises, consists essentially of, or consists of water. In embodiments, the solvent comprises, consists essentially of, or consists of a compound that is partially or completely miscible with water. In embodiments, the solvent comprises, consists essentially of, or consists of a compound that is immiscible with water. In embodiments, the solvent comprises, consists essentially of, or consists of a compound that is a liquid at 25° C./1 atm and has a flashpoint of 100° C. or less. In embodiments, the solvent includes aromatic functionality. In embodiments, the solvent comprises, consists essentially of, or consists of benzene, toluene, ethylbenzene, xylene, aromatic naphtha, or a combination of two or more thereof.

### Treatment Materials

The treatment materials included in the treatment compositions described herein comprise, consist essentially of, or consist of one or more corrosion inhibitors, one or more scale inhibitors, or a combination thereof.

Where the treatment material includes a corrosion inhibitor, the corrosion inhibitor is present in the treatment composition at a weight ratio of 1:9 to 9:1 of the corrosion inhibitor to the asphaltenic oil, for example a weight ratio of 1:8 to 9:1, or 1:7 to 9:1, or 1:6 to 9:1, or 1:5 to 9:1, or 1:4 to 9:1, or 1:3 to 9:1, or 1:2 to 9:1, or 1:1 to 9:1, or 2:1 to 9:1, or 3:1 to 9:1, or 4:1 to 9:1 or 5:1 to 9:1, or 6:1 to 9:1, or 7:1 to 9:1, or 8:1 to 9:1, or 1:9 to 8:1, or 1:9 to 7:1, or 1:9 to 6:1, or 1:9 to 5:1, or 1:9 to 4:1, or 1:9 to 3:1, or 1:9 to 2:1, or 1:9 to 1:1, or 1:9 to 1:2, or 1:9 to 1:3, or 1:9 to 1:4, or 1:9 to 1:5, or 1:9 to 1:6, or 1:9 to 1:7, or 1:9 to 1:8, or 8:1 to 1:8, or 7:1 to 1:7, or 6:1 to 1:6, or 1:5 to 5:1, or 1:4 to 4:1, or 1:3 to 3:1, or 1:2 to 2:1, or 2:3 to 3:2, or 4:3 to 3:4, or of about 1:1.

In embodiments, corrosion inhibitors usefully included in the treatment compositions described herein include, but are not limited to, amine condensates including imidazolines and amidoamines; aromatic amines includes pyridines, pyrimidines, and the like; quaternary ammonium adducts of alkyl, aromatic, or mixed alkyl and aromatic hydrocarbons; phosphate esters; aromatic amines; fatty acids or the conjugate bases thereof; organic sulfur compounds; organic sulfonic acid amines; or a combination of two or more thereof.

In embodiments, the corrosion inhibitor includes, consists essentially of, or consists of an amine condensate. The amine condensate is a reaction product of an organic compound having at least two amine groups, and often at least two primary amine groups, with an organic acid. In embodiments, the amine is ethylene diamine, diethylene triamine, triethylenetetramine, tetraethylenepentamine, N-(2-aminoethyl)-1,2-ethanediamine, or a combination of two or more thereof. In embodiments, the amine condensate is a reaction product of a diamine, triamine, or higher amine, with a fatty acid. In embodiments, the fatty acid is a saturated fatty acid, a monounsaturated fatty acid, a polyunsaturated fatty acid, or a combination of two or more thereof. In embodiments the fatty acid comprises, consists essentially of, or consists of tall oil fatty acid, naphthenic acid, lauric acid, myristic acid, palmitic acid, palmitoleic acid, stearic acid, oleic acid, linoleic acid, arachidonic acid, or a combination of two or more thereof. In embodiments, the amine condensate is a reaction product of diethylene triamine with tall oil fatty acid. In embodiments, the amine condensate is a reaction product of diethylene triamine with oleic acid.

In embodiments, the amine condensate includes, consists essentially of, or consists of an imidazoline. The term “imidazoline” refers to one or more members of the class of heterocycles derived from imidazoles by the reduction of one of the two double bonds. Unless specified otherwise, an imidazoline is a 2-imidazoline, a 3-imidazoline, a 4-imidazoline, or a mixture of two or more thereof. In embodiments, the imidazoline is a 2-imidazoline. In embodiments, the imidazoline has structure 1,

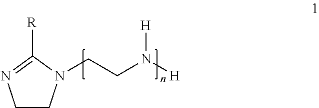

wherein R is a linear or branched alkyl, alkenyl, alkaryl, or aryl group having 12 to 30 carbons and n is an integer between 1 and 5. In embodiments, n is 1 and the imidazoline has structure 1a,

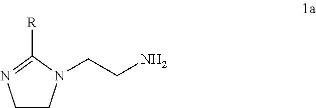

In embodiments, the amine condensate includes, consists essentially of, or consists of an amidoamine, a linear amine-functional amide. In embodiments, the amidoamine has structure 2,

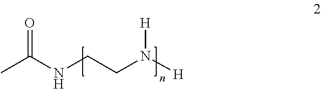

wherein R′ is a linear or branched alkyl, alkenyl, alkaryl, or aryl group having 12 to 30 carbons and n is an integer between 1 and 5. In embodiments, n is 1 and the amidoamine has structure 2a,

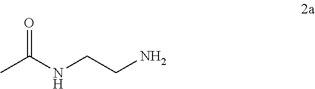

In embodiments, the corrosion inhibitor comprises, consists essentially of, or consists of a mixture of an imidazoline and an amidoamine. In embodiments, the corrosion inhibitor comprises, consists essentially of, or consists of a mixture of compounds of structure 1 and structure 2. In embodiments, the corrosion inhibitor comprises, consists essentially of, or consists of a mixture of compounds of structure 1a and structure 2a.

In embodiments, the corrosion inhibitor comprises, consists essentially of, or consists of a quaternary ammonium compound. In embodiments, the quaternary ammonium compound comprises, consists essentially of, or consists of a C10-C20 alkyl dimethyl benzyl ammonium chloride, dodecyl didecyl dimethyl ammonium chloride, hexadecyltrimethylammonium chloride, benzalkonium chloride, or a combination of two or more thereof. In embodiments, the quaternary ammonium compound comprises, consists essentially of, or consists of a C12-C18 alkyl dimethyl benzyl ammonium chloride.

In embodiments, the corrosion inhibitor comprises, consists essentially of, or consists of a phosphate ester. In embodiments, the phosphate ester comprises, consists essentially of, or consists of an ethoxylated phosphate ester. In embodiments, the phosphate ester comprises, consists essentially of, or consists of 2-ethylhexyl phosphate, 2-ethylhexyl ethoxylated phosphate, ethoxylated nonylphenol phosphate, ethoxylated phenol phosphate, styrenated and ethoxylated phenol phosphate, oleyl alcohol phosphate, phosphate esters of fatty alcohols or ethoxylated fatty alcohols, and combinations of two or more thereof.

In embodiments, the corrosion inhibitor comprises, consists essentially of, or consists of an aromatic amine. In embodiments, the aromatic amine comprise, consists essentially of, or consists of a pyrimidine, a pyridine, a quinoline, a purine, an acridine, an amino-functionalized pyrimidine, a carboxyl-functionalized pyrimidine, a conjugate base of a carboxyl-functionalized pyrimidine; and combinations of two or more thereof.

In embodiments, the corrosion inhibitor comprises, consists essentially of, or consists of a fatty acid or conjugate base thereof. In embodiments, the fatty acid comprises, consists essentially of, or consists of a saturated fatty acid, a monounsaturated fatty acid, a polyunsaturated fatty acid, or a combination of two or more thereof. In embodiments, the fatty acid comprises, consists essentially of, or consists of tall oil fatty acid, naphthenic acid, lauric acid, myristic acid, palmitic acid, palmitoleic acid, stearic acid, oleic acid, linoleic acid, arachidonic acid, or a combination of two or more thereof.

In embodiments, the corrosion inhibitor comprises, consists essentially of, or consists of an organic sulfur compound. In embodiments, the organic sulfur compound comprises, consists essentially of, or consists of comprises a thiol, a thio acid, a sulfide, a disulfide, a derivative of one of these, or a combination of two or more thereof. In embodiments, the erosion inhibitor comprises, consists essentially of, or consists of mercaptoethanol, thioglycolic acid, thiosulfate, or a combination of two or more thereof.

In embodiments, the corrosion inhibitor comprises, consists essentially of, or consists of an organic sulfonic acid amine. In embodiments, the organic sulfonic acid amine comprises, consists essentially of, or consists of aminosulfonic acid, amidosulfonic acid, imidosulfonic acid, aminosulfuric acid, amidosulfuric acid, imidosulfuric acid, a conjugate base thereof, or a combination of two or more thereof.

In embodiments, the treatment compositions include a scale inhibitor and an asphaltenic oil at a weight ratio of about 1:20 to 1:1, for example 1:15 to 1:1, or 1:10 to 1:1, or 1:5 to 1:1, or 1:2 to 1:1, or 1:20 to 1:2, or 1:20 to 1:5, or 1:20 to 1:10, or 1:20 to 1:15, or 1:15 to 1:2, or 1:15 to 1:5, or 1:15 to 1:10, or 1:10 to 1:2, or 1:10 to 1:5, or 1:2 to 1:5. In some embodiments where the treatment composition includes a scale inhibitor, the scale inhibitor is present at 1 wt % to 10 wt % of the treatment composition, for example 1 wt % to 9 wt %, or 1 wt % to 8 wt %, or 1 wt % to 7 wt %, or 1 wt % to 6 wt %, or 1 wt % to 5 wt %, or 1 wt % to 4 wt %, or 1 wt % to 3 wt %, or 1 wt % to 2 wt %, or 2 wt % to 10 wt %, or 3 wt % to 10 wt %, or 4 wt % to 10 wt %, or 5 wt % to 10 wt %, or 6 wt % to 10 wt %, or 7 wt % to 10 wt %, or 8 wt % to 10 wt %, or 9 wt % to 10 wt %, or 2 wt % to 3 wt %, or 3 wt % to 4 wt %, or 4 wt % to 5 wt %, or 5 wt % to 6 wt %, or 6 wt % to 7 wt %, or 7 wt % to 8 wt %, or 8 wt % to 9 wt %, or 1 wt % to 3 wt %, or 2 wt % to 4 wt %, or 3 wt % to 5 wt %, or 4 wt % to 6 wt %, or 5 wt % to 7 wt %, or 6 wt % to 8 wt %, or 7 wt % to 9 wt % of the treatment composition.

In embodiments, scale inhibitors usefully included in the treatment compositions described herein include, but are not limited to, condensed phosphates, polymerized organic acids, polymers comprising one or more phosphonate or phosphonate ester groups, peroxycarboxylic acids, nitrilotriacetic acid, ethylenediaminetetraacetic acid, diethylenetriamine phosphonate, phosphonic acid and diacids thereof, and combinations of two or more thereof.

In embodiments, the scale inhibitor comprises, consists essentially of, or consists of a condensed phosphate. In embodiments, the condensed phosphate comprises, consists essentially of, or consists of a poly(metaphosphate) or a phosphate salt.

In embodiments, the scale inhibitor comprises, consists essentially of, or consists of a polymer comprising one or more phosphonate or phosphonate ester groups. In embodiments, the polymer further comprises a polymerized residue of acrylic acid, methacrylic acid, vinyl sulfonic acid, vinyl phosphonic acid, maleic anhydride, itaconic acid, crotonic acid, maleic acid, fumaric acid, styrene sulfonic acid, or a combination of two or more thereof.

In embodiments, the scale inhibitor comprises, consists essentially of, or consists of a peroxycarboxylic acid, nitrilotriacetic acid, ethylenediaminetetraacetic acid, diethylenetriamine phosphonate, phosphonic acid and/or diacids thereof, or a combination of two or more thereof.

In embodiments, the treatment compositions described herein include one or more adjuvants. Adjuvants are materials or compounds that improve the ease of applying a treatment composition to a surface to form a coating thereon; and/or increase the durability of a coating of the treatment composition formed on a surface; and/or increase the corrosion inhibition of a surface by applying a treatment composition to the surface; and/or add a new type of performance to the treatment composition or to a coating formed by applying a treatment composition to a surface, such as antimicrobial, antifungal, antifouling, and/or paraffin inhibition performance.

Accordingly, in embodiments, one or more treatment compositions disclosed herein further include one or more adjuvants. In some such embodiments an adjuvant is included in a treatment composition in an amount between 0.01 wt % and 10 wt %, such as 0.01 wt % to 0.1 wt %, or 0.1 wt % to 1 wt %, or 1 wt % to 3 wt %, or 3 wt % to 5 wt %, or 5 wt % to 7 wt %, or 7 wt % to 10 wt %. In embodiments, an adjuvant is included in a treatment composition in an amount between 10 wt % and 20 wt %, such as 10 wt % to 15 wt %, 15 wt % to 20 wt %, 10 wt % to 12 wt %, 12 wt % to 14 wt %, 14 wt % to 16 wt %, 16 wt % to 18 wt %, or 18 wt % to 20 wt %.

In embodiments, a suitable adjuvant included in one or more treatment compositions comprises, consists essentially of, or consists of an antifouling agent. Antifouling agents are materials or compounds that reduce or eliminate the deposition of solids on a surface. Antifouling agents include, but are not limited to, copolymers of unsaturated fatty acids, primary diamines, and acrylic acid; copolymers of methacrylamidopropyl trimethylammonium chloride with acrylic acid and/or acrylamide; copolymers of ethylene glycol and propylene glycol; and blends of two or more thereof.

In embodiments, a suitable adjuvant included in one or more treatment compositions comprises, consists essentially of, or consists of an antimicrobial agent. Antimicrobial agents include, but are not limited to, compounds with a microbiostatic, disinfectant, or sterilization effect on a liquid material when added thereto. Nonlimiting examples of antimicrobials include bactericides, fungicides, nematicides, and the like. Bactericides include active chlorine disinfectants, e.g. including hypochlorites, chlorine dioxide, and the like; phenols such as triclosan, phenol itself, thymol, and the like; cationic surfactants such as quaternary ammonium surfactants, chlorhexidine, and the like; ozone, permanganates, colloidal silver, silver nitrate, copper based compounds, iodine preparations, peroxides, and strong acids and strong alkalis. Fungicides include, but are not limited to, strobilurins such as azoxystrobin, trifloxystrobin and pyraclostrobin; triazoles and anilino-pyrimidines such as tebuconazole, cyproconazole, triadimefon, pyrimethanil; and additionally compounds such as triadimefon, benomyl, captan, chlorothalonil, copper sulfate, cyproconazole, dodine, flusilazole, flutolanil, fosetyl-al, gallex, mancozeb, metalaxyl, prochloraz, propiconazole, tebuconazole, thiophanate methyl, triadimenol, tridimefon, triphenyltin hydroxide, ziram, and the like.

### Treated Surfaces and Methods of Treating

In accordance with the treatment compositions disclosed herein, methods of treating a surface comprise, consist essentially of, or consist of mixing a treatment material with an asphaltenic oil to form a treatment composition; and contacting a surface with the treatment composition to form a treated surface. In embodiments, the surface is a metal surface, a glass surface, a plastic surface, or a combination of two or more thereof. In embodiments, the metal surface is a carbon steel surface, a steel alloy surface, a stainless steel surface, a copper alloy surface, a yellow metal surface, or a combination of two or more thereof. In embodiments, the surface is an interior surface of a pipe or a containment, or a portion of such interior surface.

In some embodiments, contacting the surface is accomplished in a continuous process; in other embodiments, contacting the surface is accomplished in a batchwise process. In embodiments, contacting the surface is coating the surface, or applying a coating to the surface. In embodiments, the surface is coated with the treatment composition at a coating thickness of 1 μm to 1 mm, for example 1 μm to 900 μm, or 1 μm to 800 μm, or 1 μm to 700 μm, or 1 μm to 600 μm, or 1 μm to 500 μm, or 1 μm to 400 μm, or 1 μm to 300 μm, or 1 μm to 200 μm, or 1 μm to 100 μm, or 1 μm to 50 μm, or 1 μm to 25 μm, or 1 μm to 10 μm, or 10 μm to 1 mm, or 25 μm to 1 mm, or 50 μm to 1 mm, or 100 μm to 1 mm, or 200 μm to 1 mm, or 300 μm to 1 mm, or 400 μm to 1 mm, or 500 μm to 1 mm, or 600 μm to 1 mm, or 700 μm to 1 mm, or 800 μm to 1 mm, or 900 μm to 1 mm, or 10 μm to 100 μm, or 100 μm to 200 μm, or 200 μm to 300 μm, or 300 μm to 400 μm, or 400 μm to 500 μm, or 500 μm to 600 μm, or 600 μm to 700 μm, or 700 μm to 800 μm, or 800 μm to 900 μm, or 100 μm to 300 μm, or 200 μm to 400 μm, or 300 μm to 500 μm, or 400 μm to 600 μm, or 500 μm to 700 μm, or 600 μm to 800 μm, or 700 μm to 900 μm, or 800 μm to 1 mm, to form the treated surface.

In embodiments, the surface is coated by dip coating, brush coating, or spray coating. In embodiments, the surface is coated by pigging. In embodiments, pigging is carried out using a smart pig, a spray pig, a smart spray pig, or a combination of two or more thereof.

A treated surface formed in accordance with the methods disclosed herein is a surface having a coating disposed on at least a portion thereof, wherein the coating includes a treatment material and an asphaltene. Accordingly, disclosed herein is a coating disposed on a surface, the coating comprising, consisting essentially of, or consisting of a mixture of a treatment material and an asphaltene. The treatment material comprises, consists essentially of, or consists of a corrosion inhibitor and/or a scale inhibitor.

In embodiments, the coating includes 1 wt % to 50 wt % asphaltene, for example 5 wt % to 50 wt %, or 10 wt % to 50 wt %, or 20 wt % to 50 wt %, or 30 wt % to 50 wt %, or 40 wt % to 50 wt %, or 1 wt % to 40 wt %, or 1 wt % to 30 wt %, or 1 wt % to 20 wt %, or 1 wt % to 10 wt %, or 1 wt % to 5 wt %, or 5 wt % to 10 wt %, or 10 wt % to 15 wt %, or 15 wt % to 20 wt %, or 20 wt % to 25 wt %, or 25 wt % to 30 wt %, or 30 wt % to 35 wt %, or 35 wt % to 40 wt %, or 40 wt % to 45 wt %, or 45 wt % to 50 wt %, or 10 wt % to 20 wt %, or 20 wt % to 30 wt %, or 30 wt % to 40 wt %, or 40 wt % to 50 wt % asphaltene. In embodiments, the coating includes 50 wt % to 99 wt % of the treatment material.

As noted herein, the term “asphaltene” refers to the solid component of crude oil, bitumen, or coal that is toluene-soluble and n-heptane-insoluble. The study of asphaltene properties has been motivated conventionally by the tendency of the material to aggregate, flocculate, precipitate, and/or adsorb to interfaces, which in turn is associated with a host of problems in well production, pipeline transfer, land- and sea-based transportation, and refining of extracted crude oil. Asphaltene is largely insoluble in crude oil and produced water at 1 atm pressure, and once released from a subterranean reservoir tends to adsorb onto the interior surfaces of pipes and containments subjected to a flow of crude oil and/or produced water.

Without being limited by theory, we believe that after contacting a surface-such as an interior surface of a pipe or containment—with a treatment composition as described herein, the asphaltene component aggregates, flocculates, and/or precipitates, and adsorbs to the surface to provide the treated surface; and the treatment material is immobilized, or trapped within the flocculated, aggregated, and/or precipitated asphaltene matrix adsorbed on the surface. In some embodiments the treated surface is an interior surface of a pipe or containment, or a portion of the interior surface thereof; and the pipe or containment is further subjected to a fluid flow, such as a flow of crude oil and/or produced water that contacts the treated interior surface. In some embodiments, the oil present in the treatment composition, and the solvent where included in the treatment composition, elute from the coating or are washed away by the physicochemical forces associated with the fluid flow; accordingly, the coatings may include, consist essentially of, or even consist of the treatment material and asphaltene.

Unexpectedly, we have observed that the treated interior surfaces obtain improved performance durability during such fluid flow, when compared to the same treatment materials applied to the same surface(s) in the same amount, but in the absence of the asphaltenic oil. Stated differently, when a treated surface including a corrosion inhibitor is subsequently contacted with a fluid including a corrodent, corrosion of the treated surface is inhibited for a longer period of time than the same surface contacted with the same corrosion inhibitor but in the absence of the asphaltenic oil, then contacted with the same corrodent-bearing fluid. Similarly, when a treated surface including a scale inhibitor is subsequently contacted with a fluid including a mineral carbonate, scale formation on the treated surface is inhibited for a longer period of time than the same surface contacted with the same scale inhibitor but in the absence of the asphaltenic oil, then contacted with the same mineral carbonate-bearing fluid.

Accordingly, in embodiments the methods described herein comprise, consist essentially of, or consist of mixing a treatment material with an asphaltenic oil to form a treatment composition; contacting a surface with the treatment composition to form a treated surface; and contacting the treated surface with an aqueous fluid flow having one or more corrodents, one or more mineral carbonates, or a mixture thereof dissolved therein. In embodiments, the surface is an interior surface of a pipe or containment, or a portion thereof. In embodiments, the fluid flow is a flow of crude oil and/or produced water. In embodiments, the corrodent comprises, consists essentially of, or consists of H₂S.

In embodiments, the treatment material includes a corrosion inhibitor, and the treated surface obtains improved corrosion inhibition durability when subjected to the fluid flow, when compared to the same corrosion inhibitor applied to the same surface in the same amount but in the absence of the asphaltenic oil. In embodiments, the treatment material includes a scale inhibitor, and the treated surface obtains improved scale inhibition durability when subjected to the fluid flow, when compared to the same scale inhibitor applied to the same surface in the same amount, but in the absence of the asphaltenic oil. In embodiments, the mineral carbonate comprises, consists essentially of, or consists of calcium carbonate, magnesium carbonate, or a combination thereof.

In embodiments, the treatment material includes a corrosion inhibitor and a scale inhibitor, and the treated surface obtains both improved corrosion inhibition durability and scale inhibition durability when subjected to a fluid flow, compared to the same treatment material coated on the same surface in the same amount but in the absence of the asphaltenic oil. In such embodiments, the fluid flow includes both a corrodent and a mineral carbonate; in some such embodiments, the fluid flow is a crude oil flow and/or a produced water flow.

### Example

A crude oil obtained from the Gulf of Mexico was analyzed and found to include 15 wt % asphaltene. The oil was combined with a condensate of tall oil fatty acid and diethylene triamine in a 1:1 mixture by weight. A comparative treatment composition was formed by mixing 50 wt % of the condensate of tall oil fatty acid and diethylene triamine in xylene.

Corrosion inhibition performance obtained by the treatment composition and the comparative composition were assessed using a rotating immersion test. First, 10/18 stainless steel coupons were preconditioned by immersing the coupons in a 60° C., CO₂-saturated 3 wt % NaCl solution (hereinafter, “brine”) for about 3 hours, while continuously sparging the brine with CO₂ and rotating the coupons in the brine at a speed sufficient to produce a shear wall stress of about 10 Pa.

The preconditioned coupons were removed from the brine, and immediately immersed in the Treatment Composition, or in the Comparative Treatment Composition, for about 5 seconds, then removed; and excess liquid was allowed to drip from the coupon for about 10 seconds. This treatment approximates batch treatment of coating materials applied in the field to the interior of pipes by pigging. The batch treated coupons were placed in fresh brine immediately after the batch treatment, and rotated in the brine at a speed sufficient to produce a shear wall stress of about 10 Pa, while the brine was sparged with CO₂. The brine was replaced with fresh brine approximately every 24 hours thereafter, while rotating and CO₂ sparging was continuously applied throughout the duration of the 96 hour test.

The corrosion rate of the coupons was assessed electrochemically at selected intervals using linear polarization resistance methods. Corrosion rate of the coupons batch treated with the Treatment Composition is compared to the corrosion rate of coupons batch treated with the Comparative Treatment Composition, and this is further compared to the corrosion rate of a coupon that is not treated. The comparative corrosion rates are in are shown in Table 1 and the FIGURE. The FIGURE corresponds to the data in Table 1 and shows corrosion (milli-inches per year, mpy) as a function of time during the rotating immersion test of the Example. It can be seen in Table 1 and the FIGURE that the corrosion rate of the coupon treated with the Comparative composition started to rise rapidly after the first brine exchange—less than 30 hours into the test—and continued to increase for the remainder of the test, leveling out at nearly the same rate of corrosion obtained for an untreated coupon by the end of the 96 hour test. In sharp contrast, the corrosion rate of the coupon treated with the Treatment Composition continued to obtain a reduced rate of corrosion even after three brine exchanges, and after 96 hours still obtained 97% inhibition of corrosion (“protection”). Variability of the measured rate of corrosion that is observed between brine changes 2 and 3 was caused by issues with measurement equipment, and is not evidence of variability associated with the test results.

TABLE 1
Corrosion rate, milli-inches per year (mpy) measured
during the rotating immersion test of the Example.

| | | | |
|---|---|---|---|
| | | Corrosion | |
| | | Rate, 15 h | % |
| [symbol] | % | after 1st | [symbol] |
| 15 hr | Protection | brine | 15 h [symbol] |
| [symbol] | 15 hr after | change | 1st brine |
| [symbol] | dipping | (mpy) | change |

| | | |
|---|---|---|
| N/A | 575 | N/A |
| 99 | 74 | 87 |
| 99 | 4 | 99 |

[symbol]

indicates data missing or illegible when filed

What is claimed is:

1. A treatment composition comprising a mixture of a treatment material with an asphaltenic oil.

2. The treatment composition of claim 1 wherein the asphaltenic oil comprises 5 wt % to 40 wt % asphaltene, or wherein the asphaltenic oil comprises 10 wt % to 20 wt % asphaltene.

1. The treatment composition of claim 1 wherein the asphaltenic oil comprises a hydrocarbon oil, a silicone oil, a plant oil, or a combination of two of more thereof.

2. The treatment composition of claim 1 wherein the treatment material comprises a corrosion inhibitor comprising an imidazoline, a quaternary ammonium compound, a phosphate ester, an aromatic amine, a fatty acid or conjugate base thereof, an amine condensate, an organic sulfur compound, an organic sulfonic acid amine, or a combination of two or more thereof.

3. The treatment composition of claim 4 wherein the imidazoline comprises a compound having the structure 1: 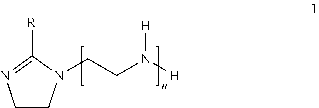
wherein R is a linear or branched alkyl, alkenyl, alkaryl, or aryl group having 12 to 30 carbons and n is an integer between 1 and 5.

4. The treatment composition of claim 5 wherein the treatment composition further comprises an amidoamine having structure 2: 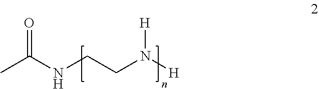
wherein R is a linear or branched alkyl, alkenyl, alkaryl, or aryl group having 12 to 30 carbons and n is an integer between 1 and 5.

5. The treatment composition of claim 4 wherein the quaternary ammonium compound comprises a C10-C20 alkyl dimethyl benzyl ammonium chloride, dodecyl didecyl dimethyl ammonium chloride, hexadecyltrimethylammonium chloride, benzalkonium chloride, or a combination of two or more thereof; and/or
wherein the phosphate ester comprises 2-ethylhexyl phosphate, 2-ethylhexyl ethoxylated phosphate, ethoxylated nonylphenol phosphate, ethoxylated phenol phosphate, styrenated, ethoxylated phenol phosphate, oleyl alcohol phosphate, phosphate esters of fatty alcohols or ethoxylated fatty alcohols, or a combination of two or more thereof; and/or
wherein the aromatic amine comprises a pyrimidine, a pyridine, a quinoline, a purine, an acridine, an amino-functionalized pyrimidine, a carboxyl-functionalized pyrimidine, a conjugate base of a carboxyl-functionalized pyrimidine; or a combination of two or more thereof; and/or
wherein the fatty acid or conjugate base thereof comprises a saturated fatty acid, a monounsaturated fatty acid, a polyunsaturated fatty acid, or a combination of two or more thereof, optionally wherein the fatty acid comprises tall oil fatty acid, naphthenic acid, lauric acid, myristic acid, palmitic acid, palmitoleic acid, stearic acid, oleic acid, linoleic acid, arachidonic acid, or a combination of two or more thereof; and/or
wherein the amine condensate is a reaction product of ethylene diamine, diethylene triamine, triethylenetetramine, tetraethylenepentamine, N-(2-aminoethyl)-1,2-ethanediamine, or a combination of two or more thereof with a saturated fatty acid, a monounsaturated fatty acid, a polyunsaturated fatty acid, or a combination of two or more thereof, optionally wherein the amine condensate is a reaction product of diethylene triamine with tall oil fatty acid; and/or
wherein the organic sulfur compound comprises a thiol, a thio acid, a sulfide, a disulfide, a derivative of one of these, or a combination of two or more thereof, wherein the organic sulfur compound comprises mercaptoethanol, thioglycolic acid, or thiosulfate, and wherein the organic sulfonic acid amine comprises aminosulfonic acid, amidosulfonic acid, imidosulfonic acid, aminosulfuric acid, amidosulfuric acid, imidosulfuric acid, a conjugate base thereof, or a combination of two or more thereof.

6. The treatment composition of claim 4 wherein the mixture comprises a weight ratio of 1:9 to 9:1 of the corrosion inhibitor to the asphaltenic oil, or wherein the mixture comprises a weight ratio of 2:3 to 3:2 of the corrosion inhibitor to the asphaltenic oil.

7. The treatment composition of claim 1 wherein the treatment material comprises a scale inhibitor, wherein the scale inhibitor comprises:
a condensed phosphate optionally selected from a poly(metaphosphate) or a phosphate salt; and/or
a polymerized organic acid, a polymer comprising one or more phosphonate or phosphonate ester groups, a peroxycarboxylic acid, nitrilotriacetic acid, ethylenediaminetetraacetic acid, diethylenetriamine phosphonate, phosphonic acid and diacids thereof, or a combination of two or more thereof; and/or
hexamethylene diamine tetrakis (methylene phosphonic acid), diethylene triamine tetra (methylene phosphonic acid), diethylene triamine penta (methylene phosphonic acid), polyacrylic acid, phosphino carboxylic acid, diglycol amine phosphonate, 1-hydroxyethylidene 1,1-diphosphonate, bisaminoethylether phosphonate, 2-acrylamido-2-methyl-1-propanesulfonic acid, or a combination of two or more thereof.

8. The treatment composition of claim 9 wherein the treatment composition comprises 1 wt % to 10 wt % of the scale inhibitor.

9. The treatment composition of claim 1 wherein the treatment material comprises a corrosion inhibitor and a scale inhibitor.

10. The treatment composition of claim 1 wherein the mixture comprises 1 wt % to 90 wt % of the treatment material, or 40 wt % to 60 wt % of the treatment material.

11. The treatment composition of claim 1 wherein the mixture further comprises 1 wt % to 80 wt % of a solvent, optionally wherein the solvent comprises an aromatic solvent selected from benzene, toluene, ethylbenzene, xylene, aromatic naphtha, or a combination of two or more thereof.

12. A coating disposed on a surface, the coating comprising a mixture of a treatment material and an asphaltene, wherein the treatment material comprises a corrosion inhibitor, a scale inhibitor, or a combination thereof.

13. The coating of claim 14 wherein the thickness of the coating is 1 μm to 1 mm.

14. The coating of claim 14 wherein the surface is a metal surface, a glass surface, a plastic surface, or a combination of two or more thereof; wherein the metal surface is a carbon steel surface, a steel alloy surface, a stainless steel surface, a copper alloy surface, a yellow metal surface, or a combination of two or more thereof.

15. A method of treating a surface, the method comprising:
mixing a treatment material with an asphaltenic oil to form a treatment composition, wherein the treatment material comprises a corrosion inhibitor, a scale inhibitor, or a combination thereof; and
contacting the surface with the treatment composition to form a treated surface.

16. The method of claim 17 wherein the contacting is carried out in a batch treatment.

17. The method of claim 17 wherein the contacting is carried out by dip coating, brush coating, spray coating, or pigging, wherein the pigging is carried out using a smart pig, a spray pig, or a smart spray pig.

18. The method of claim 17 wherein the surface comprises:
a metal surface comprising carbon steel, a steel alloy, a stainless steel, a copper alloy, a yellow metal, or a combination of two or more thereof;
a glass surface;
a plastic surface; or
a combination of two or more thereof.

19. The method of claim 20 wherein the surface is the interior surface of a pipe.

20. The method of claim 17, further comprising contacting the treated surface with a crude oil and/or a produced water.

21. The method of claim 17, further comprising
contacting the treated surface with a corrodent, optionally wherein the corrodent comprises H₂S; and/or
contacting the treated surface with a mineral carbonate, optionally wherein the mineral carbonate comprises calcium carbonate, magnesium carbonate, or a combination thereof.
